(19) United States
(12) Patent Application Publication
(10) Pub. No.: US 2011/0115143 A1
(43) Pub. Date: May 19, 2011

(54) MAGNETIC FENCE DEVICE

(76) Inventors: William J. THOMPSON, JR., LaVergne, TN (US); Helen L. Thompson, LaVergne, TN (US); Wayne A. Sutter, LaVergne, TN (US)

(21) Appl. No.: 12/619,430

(22) Filed: Nov. 16, 2009

(51) Int. Cl. B25B 11/00

(52) U.S. Cl. 269/8

(57) ABSTRACT

A magnetic fence device is disclosed which comprises a body having a topside, a front side, a rear side, an open left side, an open right side, and a bottom side, the open left side having a slot in the topside and in the bottom side. A cam mechanism is mounted in the open left side and/or open right side and the slots in the topside and the bottom side for moving the cam mechanism from a closed position to an open position. One or more magnets are positioned on the bottom side for attachment to a table of a ferromagnetic material.

### BACKGROUND OF THE INVENTION

The art of the present disclosure relates to an attachable and detachable guide in general and more particularly to a magnetic fence device for use with a tool having a tabletop. The device and method of use represents an improvement over the prior art by providing a quickly attachable fence that does not require the use of various attachment devices to hold or secure the fence to a tabletop.

Many woodworking operations such as routing, joining, and cutting involve the step of moving a workpiece past a rotating cutting tool. These operations are typically performed on a woodworking machine having a metal tabletop. Examples of such machines include router tables, shapers, joiners, jointers, band saws, and table saws. Some examples of rotating cutting tools include band saw blades, router bits, and circular saw blades. When performing a woodworking operation on a table, i.e. such as routing and cutting, a machine operator must control the path of the workpiece as it moves relative to the cutting tool. A fence may be used to assist in guiding the workpiece toward the cutting tool. A fence is typically an elongated metallic or other rigid material member that is adjustably fixed to the table or top of the machine. The fence typically includes an elongated flat guiding surface that is oriented at a substantially ninety-degree angle to the plane of the top surface of the table. A workpiece may be held by the hands of the machine operator against the guiding surface of the fence as the workpiece is moved past the cutting tool. However, there are some machines that do not have a fence and a special or auxiliary fence must be made or purchased. Such auxiliary fences can be difficult to position and attach to the top of the machine.

A feather board is a motion guide that may be utilized to prevent an occurrence known in the art as kickback. Kickback occurs when the workpiece binds to a cutting tool, for example the blade of a table saw. As a workpiece is cut on a table saw, the blade removes material from the workpiece creating an elongate kerf through the workpiece. Residual stresses within the workpiece sometimes cause the material of the workpiece to close around the blade. A portion of the workpiece may bind to the blade, causing the workpiece to be carried along with the blade as it rotates at high speed. When kickback occurs, the workpiece may be thrown upwardly and rearwardly toward the body of a saw operator and result in bodily injury. In order to avoid kickback, a feather board is attached to a fence. However, some fences do not have provisions for the attachment of a feather board. Further, as has been previously discussed, some machines do not have a fence and a special or auxiliary fence must be made or purchased. Also, the auxiliary fence may not be capable of having a feather board attached to it.

The present magnetic fence device is designed to obviate and overcome many of the disadvantages and shortcomings associated with prior fence devices. In particular, the present magnetic fence device may be easily mounted or dismounted onto a tabletop of a machine. Moreover, the present art magnetic fence device may utilize or connect with various auxiliary devices such as a feather board.

Accordingly, an object of the present disclosure is to provide a magnetic fence device and method of use that promotes easy installation and quick disconnection to a tool or a piece of equipment.

Another object of the present disclosure is to provide a magnetic fence device and method of use that may be utilized to provide an adjustable fence on machines such as a band saw, a table saw, a shaper, a router table, or a jointer.

A further object of the present disclosure is to provide a magnetic fence device that is easily removed from one machine and thereafter installed on another machine or stored.

A still further object of the present disclosure is to provide a magnetic fence device that may be inexpensively manufactured.

Another object of the present disclosure is to provide a magnetic fence device and method of use that does not require specialized removal tools to separate the device from a machine.

### SUMMARY OF THE INVENTION

To accomplish the foregoing and other objects, there is provided a magnetic fence device that comprises a body having a topside, a front side, a rear side, an open left side, an open right side, and a bottom side, a cam mechanism mounted in the open left side whereby the cam mechanism may move from a closed position to an open position, and one or more magnets positioned on the bottom side. The apparatus and method of use is especially suited for connection and repeated disconnection from a tabletop of a power tool such as a band saw, a table saw, or a router table.

In another form, the magnetic fence device is comprised of a body having a topside, a front side, a rear side, an open left side, an open right side, and a bottom side, the open left side having a slot in the topside and in the bottom side and the open right side having a slot in the topside and in the bottom side. A first cam mechanism is mounted in the open left side and the slots in the topside and the bottom side and allow for movement of the first cam mechanism from a closed position to an open position. A second cam mechanism is mounted in the open right side and in the slots in the topside and the bottom side whereby the second cam mechanism may move from a closed position to an open position. One or more magnets are positioned on the bottom side.

In yet another form of the present disclosure, a magnetic fence device comprises a body having a topside, a front side, a rear side, an open left side, an open right side, and a bottom side having a recess. A cam mechanism is mounted in the open left side thereby allowing the cam mechanism to move from a closed position to an open position. One or more magnets are positioned in the recess within the bottom side with the magnet being substantially flush with the bottom side.

### BRIEF DESCRIPTION OF THE DRAWINGS

Numerous other objects, features and advantages of the invention should now become apparent upon a reading of the following detailed description taken in conjunction with the accompanying drawings, in which:

FIG. 1 is a front perspective view of a magnetic fence device of the present disclosure;

FIG. 2 is a bottom perspective view of the magnetic fence device shown in FIG. 1;

FIG. 3 is a front side view of the magnetic fence device shown in FIG. 1;

FIG. 4 is an exploded view of the magnetic fence device shown in FIG. 1;

FIG. 5 is a front side view of the magnetic fence device positioned on a band saw tabletop with a pair of cam mechanisms in a partially operational position; and

FIG. 6 is a front side view of the magnetic fence device positioned on a band saw tabletop with the pair of cam mechanisms in a fully operational position.

### DETAILED DESCRIPTION

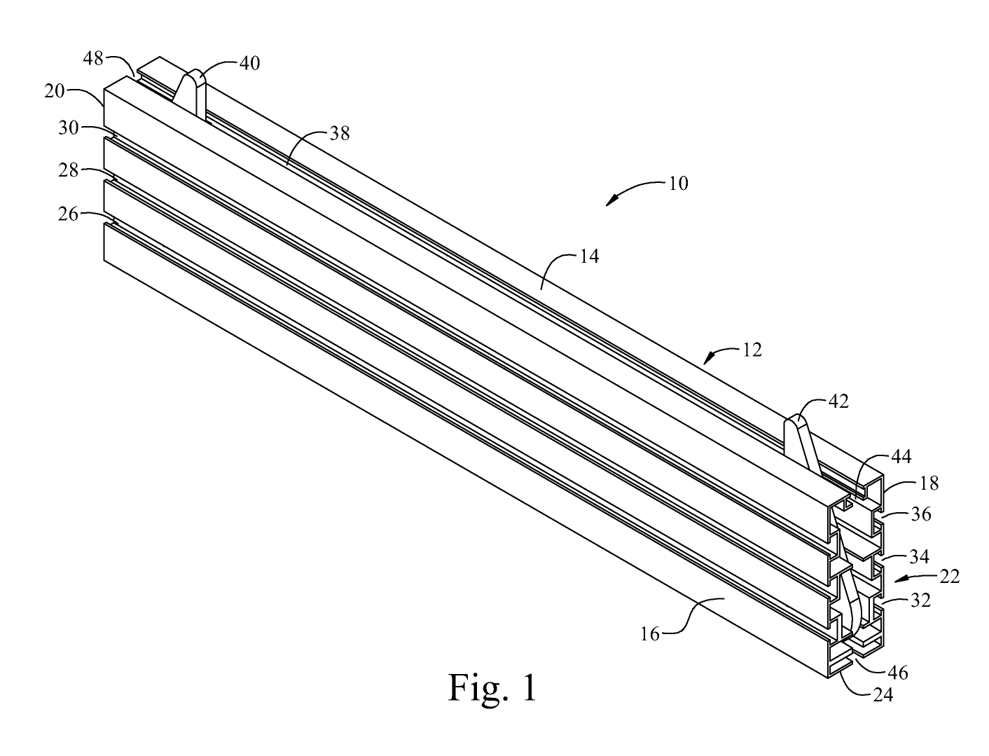

Referring now to the drawings, wherein like numbers refer to like items, number 10 identifies an embodiment of a magnetic fence device constructed according to the present disclosure. With particular reference to FIG. 1, a front perspective view of the magnetic fence device 10 is shown. The magnetic fence device 10 comprises a body 12 having a topside 14, a front side 16, a rear side 18, a left side 20, a right side 22, and a bottom side 24. The device 10 preferably has three “T” shaped slots 26, 28, and 30 formed in the front side 16, three “T” shaped slots 32, 34, and 36 formed in the rear side 18, and a single “T” shaped slot 38 formed in the top side 14. The “T” shaped slots 26, 28, 30, 32, 34, 36, and 38 are adapted to receive various accessories that are adapted to be placed in a “T” slot. The device 10 also has a pair of cam mechanisms 40 and 42 that are secured with or within the device 10. The cam mechanisms 40 and 42 are used to remove the device 10 from a tabletop, such as a band saw tabletop, as will be explained more fully in detail herein. The right side 22 is open to allow the cam mechanism 42 to move from a non-operational or closed position to a fully operational or open position, as will be explained further herein. The right side 22 has an open slot or notch 44 formed in the topside 14 and an open slot 46 formed in the bottom side 24 which allows the cam mechanism 42 to move back and forth between the non-operational position to the fully operational position. The left side 20 has a similar open construction and in this particular view an open slot 48 is depicted formed in the topside 14.

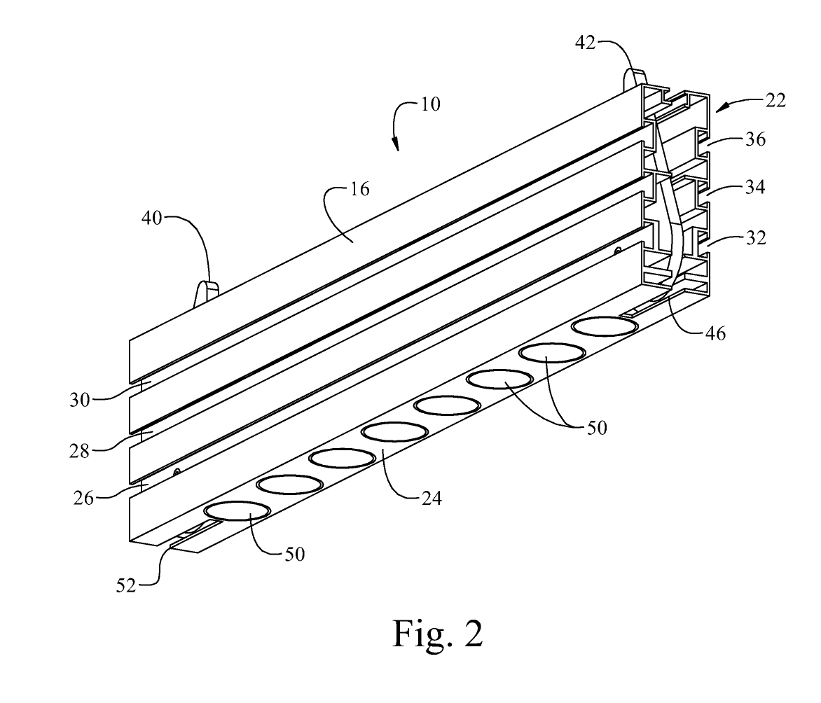

Referring now to FIG. 2, a bottom perspective view of the device 10 is illustrated. The bottom side 24 has one or more magnets 50 that are spaced along the bottom side 24. The magnets 50 preferably have a circular shape, however any shape of a magnet may be employed in the device 10. The magnets 50 may be inserted into openings or recesses formed in the bottom side 24 so that the magnets 50 are preferably substantially flush with the bottom side 24. By way of example only, a magnet may be rectangular in shape such as a strip. Although several magnets 50 are shown, it is possible and contemplated to have a single magnet such as a strip that is positioned along a portion of the length of the bottom side 24. An example of a magnet 50 is an ultra-high strength rare earth magnet, such as neodymium, that may be used for securing the device 10 to an iron or metal tabletop of a cutting machine such as a band saw. The bottom side 24 preferably also has an open slot 52 formed therein that allows the cam mechanism 40 to move or extend out of the device 10 from one position to another position.

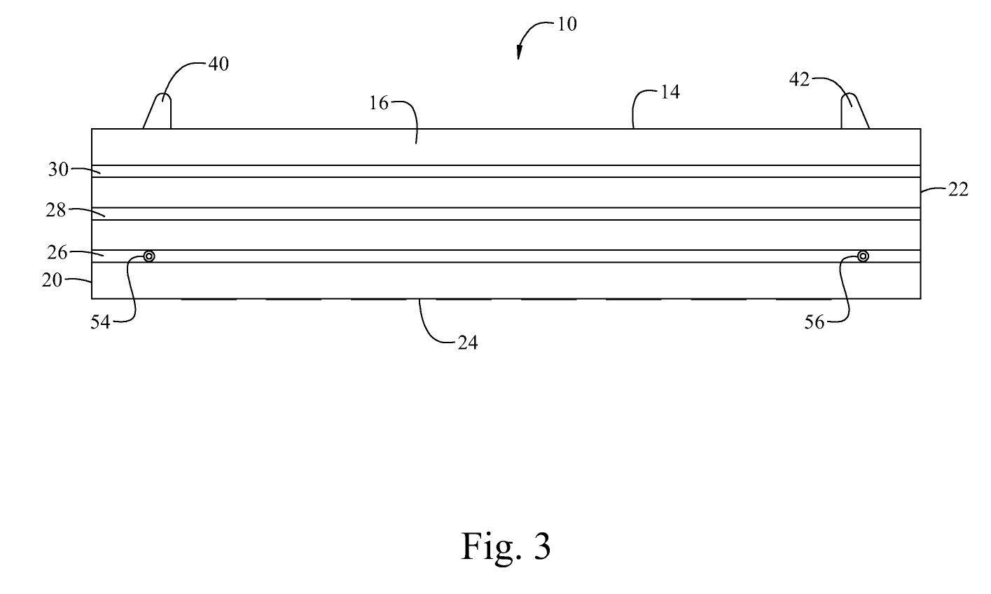

FIG. 3 illustrates a front side view of the device 10. The cam mechanism 40 is held within the device 10 by use of a bolt 54. The bolt 54 allows the cam mechanism 40 to freely rotate out of the device 10. Also, the cam mechanism 42 is held within the device 10 by a bolt 56. The bolt 56 allows the cam mechanism 42 to pivot, rotate, or move out of the device 10. The present art device 10 may utilize dowels, pins, screws, rivets, rods, or any other device or structure that will hold the cam mechanisms 40 and 42 in the device 10 and allow the cam mechanisms 40 and 42 to rotate or move, in place of said bolts 54 and 56.

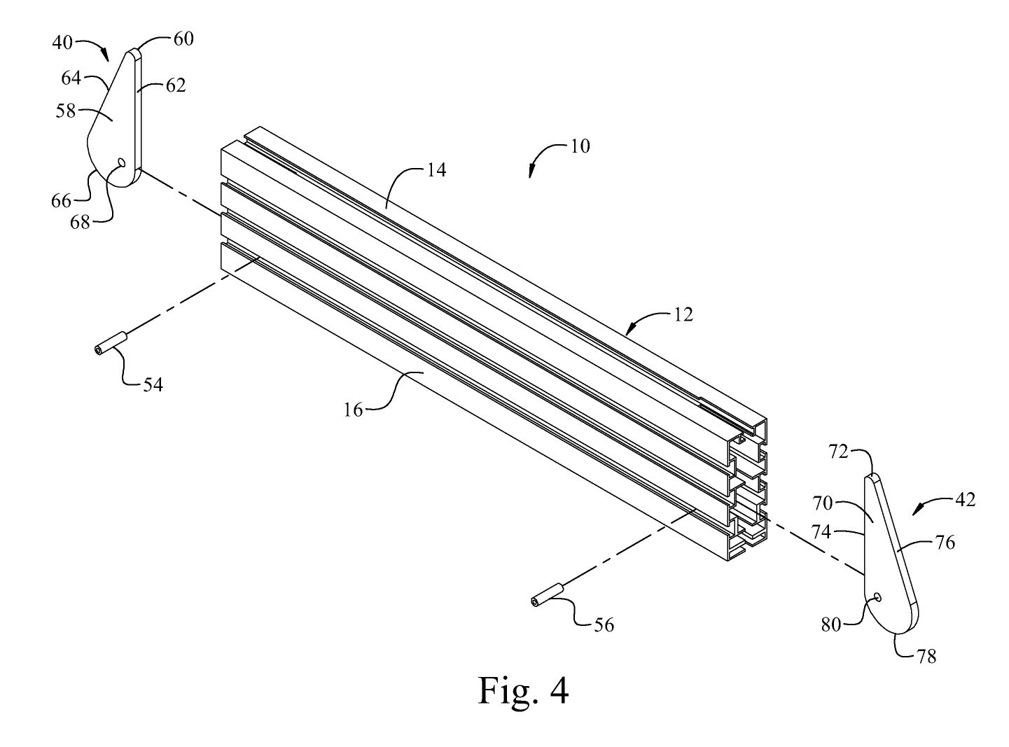

With reference now to FIG. 4, an exploded view of the device 10 is shown with the cam mechanisms 40 and 42 and the bolts 54 and 56 (i.e. in the form of pins) removed from the device 10. The cam mechanism 40 has a cam body 58 having a top or handle portion 60, a flat side 62, an angled side 64, and a rounded bottom 66. An aperture 68 is formed in the body 58 to allow the bolt 54 to pass through when the cam mechanism 40 is mounted with the device 10. The aperture 68 is preferably located off center of the rounded bottom 66. The handle portion 60 extends out of the open slot 48 of the device 10 and is adapted for being grasped by a user to operate the cam mechanism 40. The rounded bottom 66 of the cam mechanism 40 does not extend out of the open slot 52 when the cam mechanism 40 is mounted in the device 10 and is in a closed position as will be explained more fully herein. Also, the flat side 62, when mounted in the device 10 is preferably adjacent to the end of the slot 48 with the end of the slot 48 acting as a stop. Further, the cam mechanism 42 has a cam body 70 having a top or handle portion 72, a flat side 74, an angled side 76, and a rounded bottom 78. An aperture 80 is formed in the body 70 to allow the bolt 56 to pass through when the cam mechanism 42 is mounted in or with the device 10. The aperture 80 is located off center of the rounded bottom 78. The handle portion 72 extends out of the open slot 44 of the device 10 and is adapted for being grasped by a user to operate the cam mechanism 42. The rounded bottom 76 of the cam mechanism 42 does not extend out of the open slot 52 when the cam mechanism 40 is mounted in the device 10 and is in a closed position. Also, the flat side 74, when mounted in the device 10 is adjacent to the end of the slot 44 with the end of the slot 44 acting as a stop so that the cam mechanism 42 does not fall into the device 10. Although not shown in any detail, the front side 16 and the rear side 18 each have a pair of apertures through which the bolts 54 and 56 may be inserted.

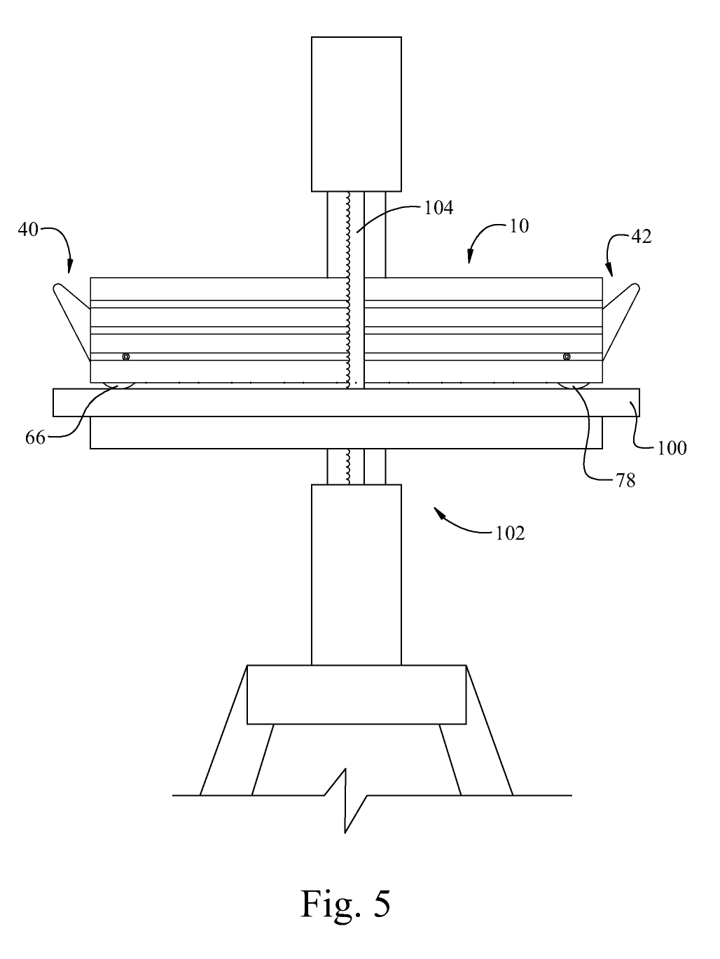

FIG. 5 shows the device 10 mounted on a tabletop 100 of a band saw 102. The tabletop 100 is typically constructed of a ferromagnetic metal that provides a surface for a magnet to adhere or be coupled. For example, the magnets 50 (not shown) are capable of magnetically coupling the device 10 to the tabletop 100 to provide a fence surface such as the side 16 of the device 10. The side 16 presents a surface against which a work piece may be positioned when cutting with the band saw blade 104. The cam mechanisms 40 and 42 are shown in a partially open position in which the rounded bottoms 66 and 78 are used to leverage the device 10 to remove the device 10 from being magnetically coupled to the tabletop 100. As previously described, the magnets 50 are ultra-high strength magnets and some mechanism is needed to assist in removing the device 10 from the tabletop 100. The cam mechanisms 40 and 42 are used to gain enough leverage to decouple the device 10 from the tabletop 100. As can be appreciated, the device 10 is particularly adapted for quick connection and repeated disconnection from the tabletop 100.

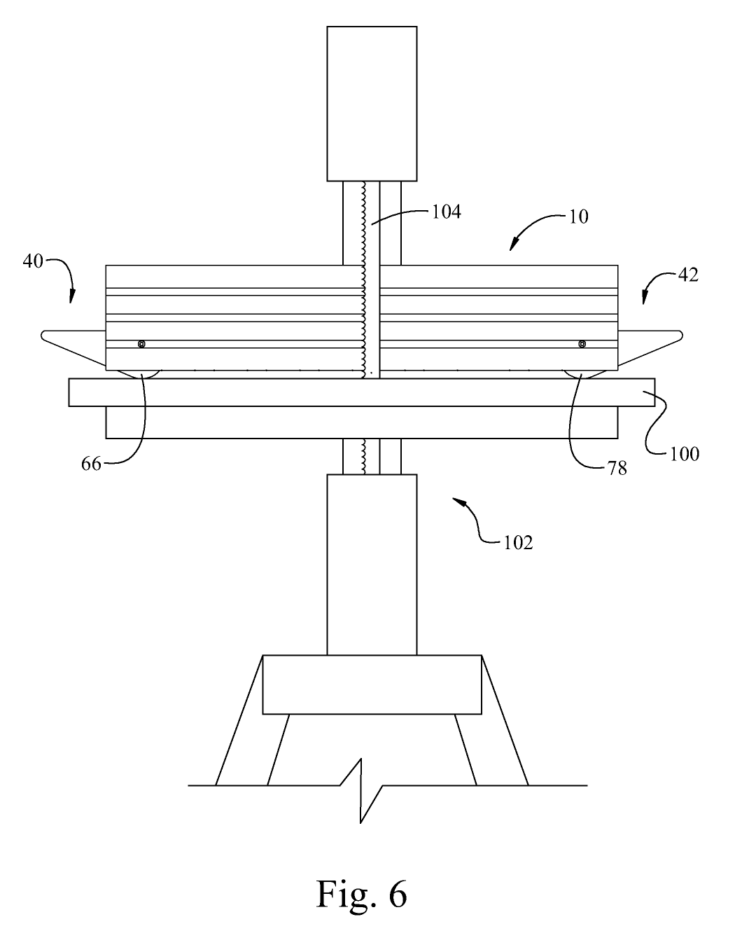

Referring now to FIG. 6, the cam mechanisms 40 and 42 are illustrated being in a fully open position to completely remove the device 10 from the tabletop 100. The cam mechanisms 40 and 42 each act as a fulcrum to pry off the device 10 from the tabletop 100. Although the cam mechanisms 40 and 42 are shown in what has been described as a fully open position, it is possible to move the cam mechanism 40 and 42 passed the fully open position if a need exists for further assistance to pry or remove the device 10 completely from the tabletop 100.

In operation of the device 10, a user determines where on a tabletop the device needs to be positioned. Once the position has been determined, the user places the device 10 on the tabletop so that the magnets 50 magnetically hold the device 10 in place. As required, accessories may be inserted into the various “T” slots 26, 28, 30, 32, 34, 36, and 38 provided in the device 10. Once in place, one or more side(s) 16, 18 may be used as a fence or a guide for a piece of wood or other material that is to be cut, shaped, or routed. Once the device 10 is no longer needed on the tabletop, the device 10 may be removed by use of the cam mechanisms 40 and 42. In particular, the handle portions 60 and 72 may be grasped and moved from a closed position to an open position. Movement of the handles 60, 72 forces the rounded bottoms 66, 78 out of their respective slots 52, 46 whereby each may press against the tabletop. In this manner, the cam mechanisms 40 and 42 act as levers to push the bottom 24 of the device 10 up and off of or away from the tabletop. The cam mechanisms 40 and 42 assist in decoupling the magnets 50 of the device 10 from the tabletop. Once removed, the device 10 can be stored, transported, or placed on another tabletop of another tool. In this manner, the device 10 can be quickly and easily connected and disconnected from a tabletop.

It is also possible that the device 10 may be constructed without any of the “T” slots 26, 28, 30, 32, 34, 36, or 38. Also, the device 10 may be constructed having one, two, or three “T” slots in the front side 16 or the rear side 18. It is further contemplated that the device 10 may include only one of the cam mechanisms 40 and 42. The device 10 may be constructed from a plurality of materials which are sufficiently strong to withstand the work piece and tool forces. These include but are not limited to aluminum, steel and other metals, plastics and polymers, and composites.

Those skilled in the art will appreciate that the magnetic fence device 10 and a method of use of the device 10 have been shown and described and that said present art is capable of easily and repeatedly being connected and disconnected from a cutting tool, machine, or piece of equipment. The device 10 with its unique design and structure along with its method of use fulfills a long felt but yet unfilled need within the arts described herein. The present art and its method of use provide a desired solution to the need of providing a fence that is easily connected to and removed from a tool table.

Having described the invention in detail, those skilled in the art will appreciate that modifications may be made to the device 10 and its method of use without departing from the spirit herein identified. Therefore, it is not intended that the scope of the device 10 be limited to the specific embodiments illustrated and described. Rather, it is intended that the scope of the device 10 be determined by the appended claims and their equivalents.

What is claimed is:

1. A magnetic fence device comprising:
a body having a topside, a front side, a rear side, an open left side, an open right side, and a bottom side;
a cam mechanism mounted in the open left side for moving the cam mechanism from a closed position to an open position; and
a magnet positioned on the bottom side.

2. The magnetic fence device of claim 1, wherein the device further comprises:
a second cam mechanism mounted in the open right side for moving the second cam mechanism from a closed position to an open position.

3. The magnetic fence device of claim 1, further comprising a T slot formed in the front side.

4. The magnetic fence device of claim 1, further comprising a T slot formed in the rear side.

5. The magnetic fence device of claim 1, further comprising a T slot formed in the topside.

6. The magnetic fence device of claim 1, further comprising a second magnet positioned on the bottom side.

7. The magnetic fence device of claim 1, wherein the cam mechanism comprises a cam body having a handle portion, a flat side, an angled side, and a rounded bottom.

8. The magnetic fence device of claim 7, wherein the cam mechanism further comprises an aperture formed in the cam body with the aperture being off center with respect to the rounded bottom.

9. The magnetic fence device of claim 1, further comprising:
a bolt for holding the cam mechanism in the body.

10. A magnetic fence device comprising:
a body having a topside, a front side, a rear side, an open left side, an open right side, and a bottom side, the open left side having a slot in the topside and in the bottom side and the open right side having a slot in the topside and in the bottom side;
a first cam mechanism mounted in the open left side and the slots in the topside and the bottom side for moving the first cam mechanism from a closed position to an open position;
a second cam mechanism mounted in the open right side and in the slots in the topside and the bottom side for moving the second cam mechanism from a closed position to an open position;
a magnet positioned on the bottom side.

11. The magnetic fence device of claim 10, further comprising a T slot formed in the front side.

12. The magnetic fence device of claim 10, further comprising a T slot formed in the rear side.

13. The magnetic fence device of claim 10, further comprising a T slot formed in the topside.

14. The magnetic fence device of claim 10, further comprising a second magnet positioned on the bottom side.

15. The magnetic fence device of claim 10, wherein the first cam mechanism comprises a cam body having a handle portion, a flat side, an angled side, and a rounded bottom.

16. The magnetic fence device of claim 15, wherein the first cam mechanism further comprises an aperture formed in the cam body with the aperture being off center with respect to the rounded bottom.

17. The magnetic fence device of claim 10, wherein the second cam mechanism comprises a cam body having a handle portion, a flat side, an angled side, and a rounded bottom.

18. The magnetic fence device of claim 17, wherein the second cam mechanism further comprises an aperture formed in the cam body with the aperture being off center with respect to the rounded bottom.

19. A magnetic fence device comprising:
a body having a topside, a front side, a rear side, an open left side, an open right side, and a bottom side having a recess;
a cam mechanism mounted in the open left side for moving the cam mechanism from a closed position to an open position; and
one or more magnets positioned in the recess in the bottom side with the magnet being substantially flush with the bottom side.

20. The magnetic fence device of claim 19, wherein the device further comprises:
a second cam mechanism mounted in the open right side for moving the second cam mechanism from a closed position to an open position.
